(19) United States
(12) Patent Application Publication
(10) Pub. No.: US 2016/0075273 A1
(43) Pub. Date: Mar. 17, 2016

(54) Method and device for operating a cornering light to be emitted by a headlight for a vehicle

(71) Applicant: Robert Bosch GmbH, Stuttgart (DE)

(72) Inventor: Stephan STUEHMER, Rutsheim (DE)

(21) Appl. No.: 14/849,841

(22) Filed: Sep. 10, 2015

(30) Foreign Application Priority Data
Sep. 16, 2014 (DE) 10 2014 218 572.6

(51) Int. Cl. B60Q 1/14

(52) U.S. Cl. CPC B60Q 1/1423; B60Q 2300/40

(57) ABSTRACT

A method for operating a cornering light to be emitted by a headlight for a vehicle, the method including determining a headlight control signal for varying the cornering light using a piece of traffic information. The piece of traffic information represents a position of the vehicle at and/or in a traffic circle.

### RELATED APPLICATION INFORMATION

The present application claims priority to and the benefit of German patent application no. 10 2014 218 572.6, which was filed in Germany on Sep. 16, 2014, the disclosure of which is incorporated herein by reference.

### FIELD OF THE INVENTION

The present invention relates to a method for operating a cornering light to be emitted by a headlight for a vehicle, to a corresponding device for operating a cornering light to be emitted by a headlight for a vehicle, and to a corresponding computer program.

### BACKGROUND INFORMATION

Situations in which the oncoming traffic is dazzled repeatedly occur in vehicles which are equipped with a bending light or an adaptive cornering light. Systems are presently under development which do not additionally illuminate these areas when oncoming traffic is detected (with the aid of a front camera, for example) to avoid dazzling.

### SUMMARY OF THE INVENTION

Against this background, the approach described here introduces an improved method for operating a cornering light to be emitted by a headlight for a vehicle, furthermore an improved device for operating a cornering light to be emitted by a headlight for a vehicle which uses this method, and finally a corresponding computer program as recited in the main claims. Advantageous embodiments are derived from the particular subclaims and the following description.

A bending light and an adaptive cornering light, hereafter referred to in summary as a cornering light, may illuminate an area ahead of a vehicle which is adapted to the road construction circumstances, such as a traffic circle. Depending on the position of the vehicle in or at the traffic circle, the cornering light may be deactivated, or a deflection or pivot angle of the cornering light may be adapted or decreased, to reduce or avoid dazzling of another road user.

A method for operating a cornering light to be emitted by a headlight for a vehicle is introduced, the method including the following step:

determining a headlight control signal for varying the cornering light using a piece of traffic information which represents a position of the vehicle at and/or in a traffic circle.

The vehicle may be a motor vehicle such as a motorcycle, a passenger car, a bus or a truck. The vehicle may include at least one headlight. The at least one headlight may include a cornering light or provide or emit such a cornering light. The vehicle may include at least one right headlight for a cornering light to be emitted by a headlight and at least one left headlight for a cornering light to be emitted by a headlight. The headlight may be a front headlight, a vehicle headlight or another light source of the vehicle. The headlight may include multiple light sources, at least one light source being configured as a cornering light. A cornering light may be understood to mean a headlight or a portion of a headlight which is able to vary its lighting direction in the turn direction when the vehicle is negotiating a turn. A cornering light may improve an illumination ahead of the vehicle. A cornering light may be understood to mean an adaptive cornering light or a bending light. In this way, an adaptive cornering light may be implemented by an adaptively pivoting headlight. A bending light may be understood to mean a static cornering light, an activatable separate light function or a headlight which is individually illuminating when negotiating a turn, such as a fog light, for example. For example, the bending light may be activated at a speed of the vehicle below 40 km/h and a simultaneous actuation of a turn signal or when a predefined minimum steering wheel revolution is exceeded. A piece of traffic information may be understood to mean an analog or digital signal which represents the position of the vehicle in a traffic circle or the position of the vehicle at or near a traffic circle. A varying may be understood to mean, for example, a deactivating of the at least one headlight, a pivoting of the at least one headlight and/or a varying of the light emission, i.e., a dimming of the light emitted by the headlight.

Moreover, the method may include a step of ascertaining the piece of traffic information, which precedes the step of determining. In the step of ascertaining, the piece of traffic information may be ascertained using camera-based sign recognition and simultaneously or alternatively camera-based traffic circle recognition. Alternatively or additionally, the piece of traffic information may be ascertained using navigation data and simultaneously or alternatively map data. Additionally or alternatively, the piece of traffic information may be ascertained using a rotation rate signal and simultaneously or alternatively a rotation angle signal. The vehicle may include a camera which is configured to record an image. The camera may be configured to recognize a detected road sign and thus recognize a position of the vehicle at or in a traffic circle to be driven through. For example, in Germany the StVO (highway code) sign 215, in Switzerland the SSV (sign ordinance) sign 2.41.1, or in Austria the StVZVO (traffic sign ordinance) hazard sign 3a may be recognized and evaluated and provided as traffic information. The camera may be configured to recognize a traffic circle or a position of the vehicle in the traffic circle in the absence of signage. In one exemplary embodiment, the vehicle may include satellite-based position recognition. Using the satellite-based position recognition and map data, it is possible to determine the piece of traffic information. The vehicle may include at least one rotation rate sensor. The rotation rate sensor may be configured to detect a rotation angle and/or a rotation rate of the vehicle or a steering of the vehicle and provide this as a rotation rate signal or rotation angle signal. A change from right to left in right-hand traffic, for example, may identify an entrance into a traffic circle. Alternatively or additionally, the entering into a traffic circle may also be recognized by evaluating other driving state signals such as a speed and a signal of a wheel impulse counter.

In the step of determining, the headlight control signal may be determined using a piece of information about driving the vehicle in right-hand traffic or in left-hand traffic. Left-hand traffic and right-hand traffic each describe traffic corresponding to a traffic lane on which road users usually drive or a road side on which road users evade each other. In right-hand traffic, for example, which is customary in Germany, an oncoming vehicle passes to the left side of the host vehicle. In this way, a left bending light or cornering light may be deactivated in right-hand traffic, for example, and a right bending light or cornering light may be deactivated in left-hand traffic, when driving in a traffic circle or in the case of a position of the vehicle in a traffic circle.

The headlight control signal determined in the step of determining may represent a control signal for deactivating and simultaneously or alternatively pivoting at least one headlight of the vehicle. For example, an angle by which the cornering light or the headlight is pivoted may relate to a position of the vehicle or be adapted to a traffic circle or be varied.

It is also favorable if, in the step of determining, the headlight control signal is determined using a piece of information about a diameter of the traffic circle. In this way, an area to be illuminated by the at least one headlight of the vehicle may be adapted. A headlight range or a pivot angle of a headlight or a cornering light on the inside of the turn may be varied in response to the headlight control signal. In this way, a more robust headlight control signal may be provided.

Moreover, the method may include a step of reading in the piece of traffic information which precedes the step of determining. In this way, the piece of traffic information may be effectively read in as an analog or digital signal and provided to the steps of the method.

Moreover, the method may include a step of providing a headlight control signal to an interface to the headlight, which follows the step of determining. In this way, the headlight control signal may be effectively provided at an interface for the headlight or for a headlight control unit. The headlight control signal may be provided as a digital or analog headlight control signal.

The approach described here furthermore creates a device which is configured to carry out, activate or implement the steps of one variant of a method described here in corresponding devices. The object of the present invention may also be achieved quickly and efficiently by this embodiment variant of the present invention in the form of a device.

A device in the present invention may be understood to mean an electrical device which processes sensor signals and outputs control signals and, simultaneously or alternatively, data signals as a function thereof. The device may include an interface which may be configured as hardware and/or software. In the case of a hardware configuration, the interfaces may, for example, be part of a so-called system ASIC which includes a wide variety of functions of the device. However, it is also possible for the interfaces to be separate integrated circuits, or to be at least partially composed of discrete elements. In the case of a software configuration, the interfaces may be software modules which are present on a microcontroller, for example, in addition to other software modules.

In addition, a computer program product or computer program is advantageous, having program code which may be stored on a machine-readable carrier or storage medium such as a semiconductor memory, a hard disk memory or an optical memory, and which is used to carry out, implement and/or activate the steps of the method according to one of the specific embodiments described above, in particular if the program product or program is executed on a computer or a device.

The approach introduced here is described in greater detail hereafter based on the accompanying drawings by way of example.

### BRIEF DESCRIPTION OF THE DRAWINGS

FIG. 1 shows a schematic representation of a vehicle including a device for varying a cornering light of a headlight for the vehicle according to one exemplary embodiment of the present invention.

FIG. 2 shows a schematic representation of a device for varying a cornering light to be emitted by a headlight for a vehicle according to one exemplary embodiment of the present invention.

FIG. 3 shows a schematic representation of vehicles in positions at or in a traffic circle according to one exemplary embodiment of the present invention.

FIG. 4 shows a flow chart of a method for varying a cornering light to be emitted by a headlight for a vehicle according to one exemplary embodiment of the present invention.

### DETAILED DESCRIPTION

In the following description of favorable exemplary embodiments of the present invention, identical or similar reference numerals are used for similarly acting elements shown in the different figures, and a repeated description of these elements is dispensed with.

FIG. 1 shows a schematic representation of a vehicle 100 including a device 102 for operating a cornering light 104 of a headlight 106 for vehicle 100 according to one exemplary embodiment of the present invention. In addition to headlight 106, vehicle 100 includes another headlight 108. Headlights 106, 108 are front headlights of vehicle 100. In the exemplary embodiment, headlight 106 is a left headlight and further headlight 108 is a right headlight of vehicle 100. Headlights 106, 108 include a functionality of a cornering light 104, 110. Device 102 is configured to provide a headlight control signal 112 for varying cornering light 104, 110 using a piece of traffic information 114 at an interface of headlights 106, 108. The piece of traffic information 114 represents a position of vehicle 100 at or in a traffic circle.

In the exemplary embodiment shown in FIG. 1, vehicle 100 includes a device 116 for providing the piece of traffic information 114. Depending on the exemplary embodiment, device 116 may include camera-based sign recognition, camera-based traffic circle recognition, satellite-based position recognition, a navigation system or a rotation rate sensor and ascertain the piece of traffic information 114 using signals of one or of a combination of at least two of the described units.

In the exemplary embodiment shown in FIG. 1, device 102 is configured to reduce dazzling of the oncoming traffic by the conditional deactivation of the bending light or cornering light of headlight 106 and, additionally or alternatively, of headlight 108. For this purpose, device 102 uses the road construction circumstances as a basis for activating or varying the bending light or cornering light. In particular in traffic circles, the oncoming traffic waiting to enter the traffic circle is dazzled by vehicles situated in the circle having an active bending light or cornering light 104, 110. Following vehicles or vehicles entering one entrance earlier may thus be detected too late.

If device 102, in response to the piece of traffic information 114, detects that vehicle 100 is located in a traffic circle, in one exemplary embodiment the left bending light is deactivated in the case of right-hand traffic, and the right bending light in the case of left-hand traffic. Depending on the exemplary embodiment, the circle recognition or traffic circle recognition is carried out with the aid of front camera-based sign recognition (for example StVO sign 215), with the aid of a front camera algorithm which recognizes a traffic circle even in the absence of signage, based on navigation and map data or with the aid of movement pattern recognition using at least one rotation rate sensor, such as a switch from right to left when entering the traffic circle in right-hand traffic, or a switch from left to right in left-hand traffic.

In one exemplary embodiment, the areas to be illuminated or the headlight range of the light on the inside of the turn is adapted based on the circle recognition. When vehicle 100 is about to enter the circle, the bending light on the outside of the turn may also be deactivated.

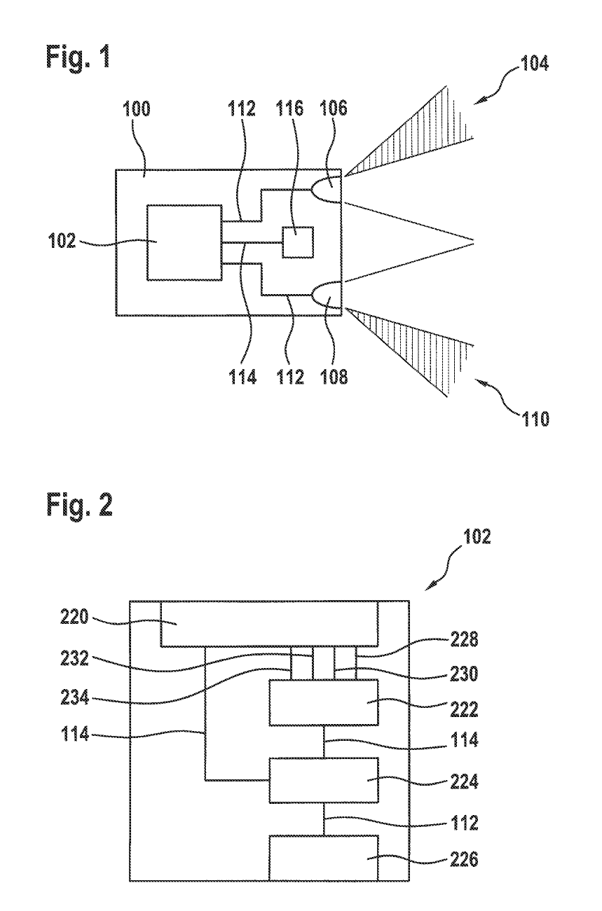

FIG. 2 shows a schematic representation of a device 102 for operating a cornering light of a headlight for a vehicle according to one exemplary embodiment of the present invention. Device 102 may be one exemplary embodiment of a device 102 for varying a cornering light of a headlight shown in FIG. 1.

Device 102 is configured to determine a headlight control signal 112 for varying the cornering light of the headlight using a piece of traffic information 114. The piece of traffic information 114 represents a position of the vehicle at or in a traffic circle. Device 102 includes an interface 220 for reading in, a unit 222 for ascertaining, a unit 224 for determining, and an interface 226 for providing. Unit 224 for determining represents the core of device 102. Unit 224 for determining is configured to determine a headlight control signal 112 for varying the cornering light of the headlight using the piece of traffic information 114. Headlight control signal 112 represents a control signal for deactivating or pivoting at least one headlight of the described vehicle. Depending on the exemplary embodiment, the piece of traffic information 114 is either read in via interface 220 for reading in or is ascertained by optional unit 222 for ascertaining using a camera signal 228, a position signal 230 and map data 232, or a rotation rate signal 234 or rotation angle signal 234. If device 102 includes optional unit 222 for ascertaining, interface 220 is configured to read in necessary data 232 or signals 228, 230, 234 and provide the same to unit 222 for ascertaining.

In one exemplary embodiment, unit 224 for determining is configured to determine headlight control signal 112 using a piece of information about driving the vehicle in right-hand traffic or in left-hand traffic. Depending on the exemplary embodiment, the piece of information about driving the vehicle in right-hand traffic or in left-hand traffic is permanently stored in unit 224 for determining, is ascertained by unit 222, or is read in via interface 220.

In one exemplary embodiment, unit 224 for determining is configured to determine headlight control signal 112 using a piece of information about a diameter of the traffic circle. Depending on the exemplary embodiment, the piece of information about the diameter of the traffic circle is ascertained by unit 222 or read in via interface 220.

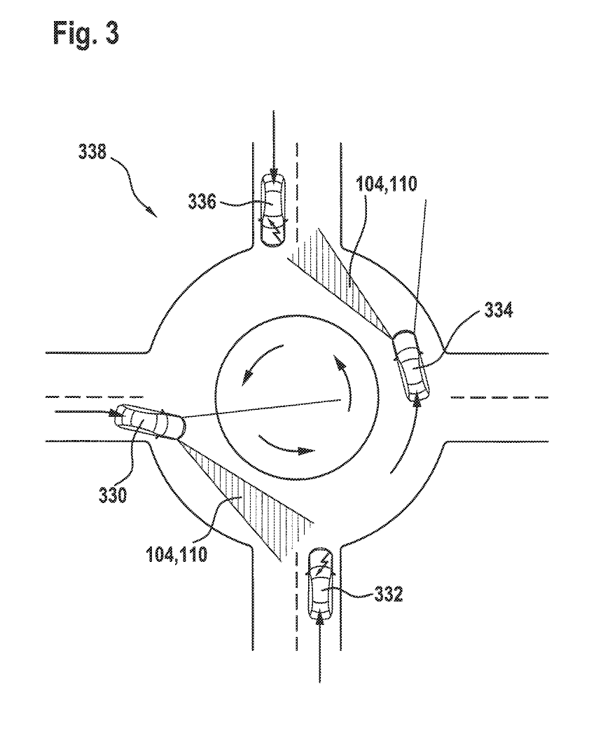

FIG. 3 shows a schematic representation of vehicles 330, 332, 334, 336 in positions at or in a traffic circle 338 according to one exemplary embodiment of the present invention. The represented traffic circle 338 shows a situation in the case of right-hand traffic. Vehicles 330, 334 may involve exemplary embodiments of a vehicle 100 shown in FIG. 1. Traffic circle 338 has a circular roadway having a center island. Traffic circle 338 furthermore has four access roads or four entrances and exits. Shown vehicles 330, 332, 334, 336 are illustrated in different positions relative to traffic circle 338 or the access roads. Vehicle 330 has already turned half way from the first access road into traffic circle 338. If vehicle 330 has a cornering light 104, 110, and no device for operating a cornering light 104, 110 of a headlight, as is described in FIG. 1 and FIG. 2, in this situation right cornering light 110 of vehicle 330 is active and illuminates vehicle 332 waiting in the next or second access road. As a result, a driver of vehicle 332 is dazzled. A device for operating a cornering light of a headlight for vehicle 330 is configured to reduce a pivoting of cornering light 110 in the direction of waiting vehicle 332 or alternatively to deactivate cornering light 110 of vehicle 330. A third vehicle 334 is positioned on the circular roadway in the area of a third access road situated opposite the first access road. A steering system of vehicle 334 has a steering angle to the left, so that during normal operation a left cornering light 104 of vehicle 334 is active, or cornering light 104 of vehicle 334 is pivoted from the driving direction to the left. To prevent dazzling of a vehicle 336 waiting in a fourth access road following the third access road by cornering light 104 of vehicle 334, a device for varying cornering light 104, 110 of the headlight of vehicle 334 is configured to reduce a pivoting of cornering light 104 in the driving direction to the left or alternatively to deactivate the inner cornering light 104 in the circular arc.

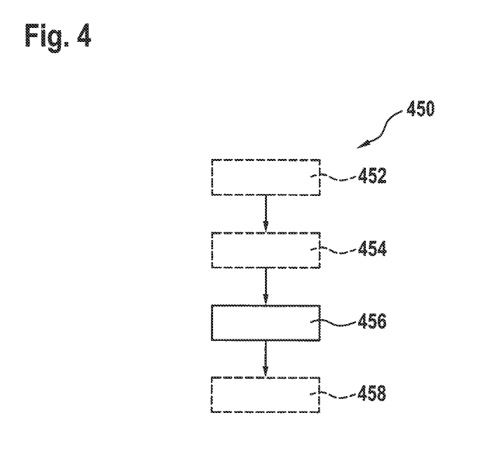

FIG. 4 shows a flow chart of a method 450 for operating a cornering light to be emitted by a headlight for a vehicle according to one exemplary embodiment of the present invention. The vehicle may be one exemplary embodiment of a vehicle 100 shown in FIG. 1. Method 450 includes a step 452 of reading in, a step 454 of ascertaining the piece of traffic information, a step 456 of determining a headlight control signal, and a step 458 of providing the headlight control signal to an interface to the headlight.

In one exemplary embodiment, the piece of traffic information is read in in step 452 of reading in, a headlight control signal for varying the cornering light of the headlight using the piece of traffic information is determined in step 456 of determining, and the headlight control signal is provided to an interface to the headlight in step 458 of providing.

In one alternative exemplary embodiment, in step 454 of ascertaining the piece of traffic information is ascertained using camera-based sign recognition or traffic circle recognition, using navigation and map data, or using a rotation rate signal and subsequently, in step 456 of determining, the headlight control signal is determined using the piece of traffic information and, in step 458 of providing, the headlight control signal is provided.

In one exemplary embodiment, in step 452 of reading in, a camera signal, a position signal, map data and, additionally or alternatively, a rotation rate signal is/are read in. In subsequent step 454 of ascertaining, the piece of traffic information is ascertained using at least one signal read in in step 452 of reading in. As in the above-described exemplary embodiment, the headlight control signal is determined using the piece of traffic information in step 456 of determining, and the headlight control signal is provided in step 458 of providing.

Depending on the exemplary embodiment, step 452 of reading in, step 454 of ascertaining, and step 458 of providing are optional steps of method 450 for operating the cornering light of the headlight for the vehicle.

The described exemplary embodiments shown in the figures are selected only by way of example. Different exemplary embodiments may be combined with each other completely or with respect to individual features. It is also possible to supplement one exemplary embodiment with features of another exemplary embodiment.

Moreover, the method steps introduced here may be carried out repeatedly and in a different order than the one described.

If one exemplary embodiment includes an “and/or” linkage between a first feature and a second feature, this should be read in such a way that the exemplary embodiment according to one specific embodiment includes both the first feature and the second feature, and according to an additional specific embodiment includes either only the first feature or only the second feature.

What is claimed is:

1. A method for operating a cornering light to be emitted by a headlight for a vehicle, the method comprising:
determining a headlight control signal for varying the cornering light using a piece of traffic information which represents a position of the vehicle at and/or in a traffic circle.

2. The method of claim 1, further comprising:
ascertaining the piece of traffic information, which precedes the determining, using at least one of camera-based sign recognition, camera-based traffic circle recognition, navigation data, map data, a rotation rate signal, a rotation angle signal, and by evaluating at least one other driving state signal.

3. The method of claim 1, wherein the headlight control signal is determined using a piece of information about driving the vehicle in right-hand traffic or in left-hand traffic.

4. The method of claim 1, wherein the headlight control signal represents a control signal for deactivating and/or pivoting at least one headlight of the vehicle.

5. The method of claim 1, wherein the headlight control signal is determined using a piece of information about a diameter of the traffic circle.

6. The method of claim 1, further comprising:
reading in the piece of distance information, which precedes the determining.

7. The method of claim 1, further comprising:
providing the headlight control signal to an interface to the headlight, which follows the determining.

8. A device for operating a cornering light to be emitted by a headlight for a vehicle, comprising:
a determining arrangement to determine a headlight control signal for varying the cornering light using a piece of traffic information which represents a position of the vehicle at and/or in a traffic circle.

9. A computer readable medium having a computer program, which is executable by a processor, comprising:
a program code arrangement having program code for operating a cornering light to be emitted by a headlight for a vehicle, by performing the following:
determining a headlight control signal for varying the cornering light using a piece of traffic information which represents a position of the vehicle at and/or in a traffic circle.

10. The computer readable medium of claim 9, further including performing the following:
ascertaining the piece of traffic information, which precedes the determining, using at least one of camera-based sign recognition, camera-based traffic circle recognition, navigation data, map data, a rotation rate signal, a rotation angle signal, and by evaluating at least one other driving state signal.

11. The computer readable medium of claim 9, further including performing the following:
ascertaining the piece of traffic information, which precedes the determining, using at least one of camera-based sign recognition, camera-based traffic circle recognition, navigation data, map data, a rotation rate signal, a rotation angle signal, and by evaluating at least one other driving state signal, in particular a speed or a signal of a wheel impulse counter.

12. The method of claim 1, further comprising:
ascertaining the piece of traffic information, which precedes the determining, using at least one of camera-based sign recognition, camera-based traffic circle recognition, navigation data, map data, a rotation rate signal, a rotation angle signal, and by evaluating at least one other driving state signal, in particular a speed or a signal of a wheel impulse counter.
